(19) United States
(12) Patent Application Publication
(10) Pub. No.: US 2006/0237945 A1
(43) Pub. Date: Oct. 26, 2006

(54) Common axis drive and shift system

(76) Inventor: Jerome E. Hauer, Elko, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/101,931

(22) Filed: Apr. 8, 2005

(51) Int. Cl. B62M 1/02

(52) U.S. Cl. 280/260

(57) ABSTRACT

A coaxially located crankshaft and wheel utilize a second radially spaced shaft to transmit power from the crankshaft back to the wheel. Multiple gears may be shifted between. In one embodiment, the wheel is a front wheel of a bicycle. The crankshaft includes pedals, and a first sprocket for transmitting pedal power to a first drive chain. The first drive chain couples to a second sprocket on a second shaft, which transmits power to a second drive chain via a third sprocket or set of sprockets on the second shaft. A second chain couples the third set of sprockets to a fourth set of sprockets, coaxially located with the wheel and crankshaft.

### BACKGROUND

Front wheel drive bicycles include some of the first bicycles ever used. Such bicycles were powered by a pedaled crank shaft coaxially located with the front wheel. The front wheel was made large in order to allow for higher speeds without having to crank the wheel too fast.

An improvement to such front wheel drive bicycles is shown in U.S. Pat. No. 906,293, which shows a way to further reduce the cranking speed of the pedals, and obtain even higher speeds. A large front wheel with a hub and pedal cranks on a driving shaft, and a separate power transmitting shaft 33, with different gearing on each side permit high speed with a comparatively slow motion of the pedal cranks. One chain transmits power from the pedal crank to the power transmitting shaft, and a second, drive chain transmits power from the power transmitting shaft to the wheel.

U.S. Pat. No. 5,403,027 shows a rear wheel of a bicycle with a rotating shaft and rotatably mounted crankshaft. A speed change wheel and a pair of chains are used to transmit the rotating force to a free wheel on the rear wheel of the bicycle. One object of the device is to make the rotating center of a chain wheel as well as the rotating center of a rear wheel concentric with a crankshaft and locating the rotating center of the crankshaft on or behind the vertical center line of the saddle. This appeared to provide a means of easier folding of the bicycle and moving of the wheels closer together.

These bicycles may have been better suited for higher speeds, but were not well suited for slow speeds, or varied terrain, such as terrain including hills. Many current bicycles include a crankshaft located between front and back wheels, and one or more variable gears to make it easier to handle varied terrain or ride comfortably at desired speed.

### SUMMARY

A coaxially located crankshaft and wheel utilize a second shaft or hub to transmit power from the crankshaft back to the wheel. Multiple gears may be shifted between.

In one embodiment, the wheel is a front wheel of a bicycle. The crankshaft includes pedals, and a first sprocket for transmitting pedal power to a first drive chain. The first drive chain couples to a second sprocket on a second shaft, which transmits power to a second drive chain via a third sprocket or set of sprockets on the second shaft. A second chain couples the third set of sprockets to a fourth set of sprockets, coaxially located with the wheel and crankshaft.

In one embodiment, the fourth set of sprockets comprises a free wheel. A rider controllable derailleur controls the second chain's position on the fourth set of sprockets. In one embodiment, a second derailleur is used to control the second chain's position on the third set of sprockets to increase the number of gears available to the rider.

The first a second chains may be located on opposite sides of the wheel and a frame that is used to support the wheel and second shaft. The frame may also support a seat for the rider, a second wheel, such as a rear wheel, brakes, shift cables, and other parts that are common on bicycles.

In still further embodiments, the frame is in the shape of a unicycle, providing a multi-geared unicycle. The frame may also include two additional wheels, forming a recumbent three wheeled bicycle. Multiple additional frames may be utilized, including rear wheel drive embodiments.

### BRIEF DESCRIPTION OF THE DRAWINGS

FIG. 1 is a side view diagram of a common axis drive and shift mechanism.

FIG. 2 is a side view diagram of the other side of the common axis drive and shift mechanism of FIG. 1.

FIG. 3 is a rear elevation view diagram of the common axis drive and shift mechanism of FIG. 1.

FIG. 4 is a side elevation diagram of a bicycle incorporating the common axis drive and shift mechanism of FIG. 1.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

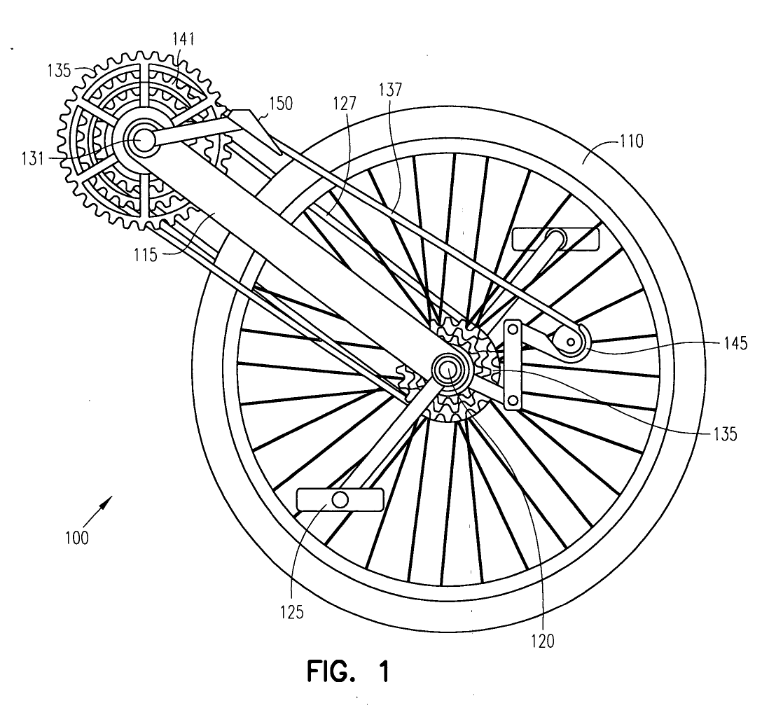

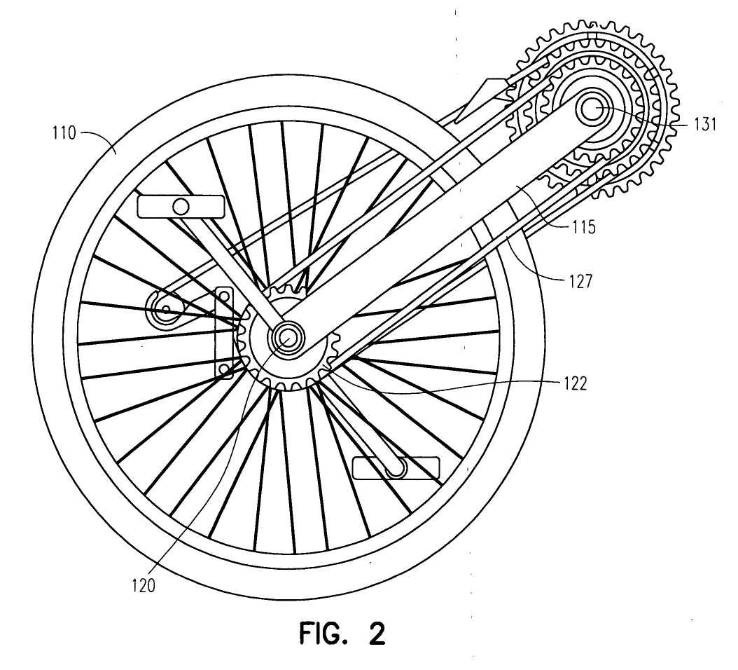

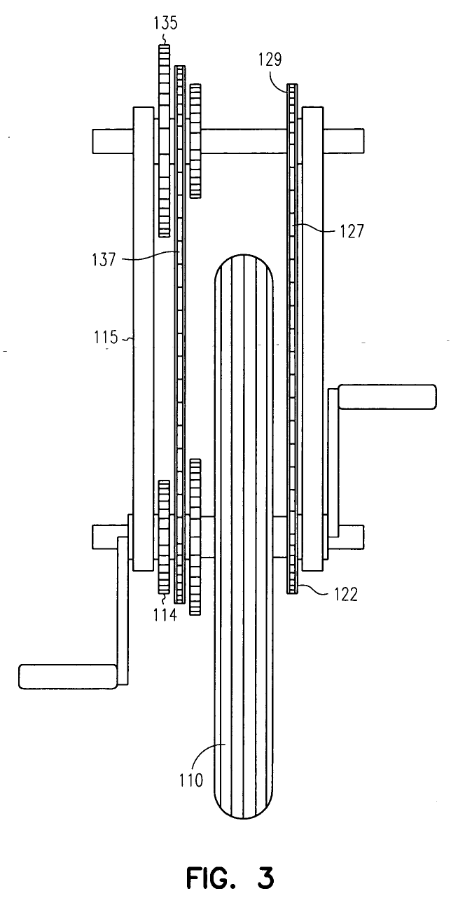

A common axis drive and shift mechanism is illustrated generally at 100 in FIGS. 1, 2 and 3. System 100 comprises a wheel 110 supported by a frame 115. An axis or hub of the wheel includes a rotatable crankshaft 120 having a first sprocket or gear 122 coupled to the crankshaft. In one embodiment, crankshaft 120 and first gear 122 rotate freely within the wheel, and may be driven by means such as pedals 125, or a motor or other means providing a rotating force, including by hand and/or foot.

First gear 122 is located on a first side of the wheel 110 and frame 115 in one embodiment. A first chain 127 or other type of power coupling mechanism is coupled to first gear 122 and extends to a second sprocket or gear 129. When first gear 122 rotates, the chain 127 causes rotation of the second gear 129, which is supported by a second shaft or hub 131. Second shaft 131 is shown rotatably supported by frame 115 and located just outside the radius of wheel 110 in one embodiment. While it may be located anywhere outside the radius of wheel 110, chain length and hence weight of system 100 may be reduced by locating closely outside the radius.

Second shaft 131 has a third set of gears or sprockets 135 located on a second side of the wheel 110 and frame 115. The second shaft 131 transmits rotational power from the second gear 129 to the third set of gears 135. A second chain 137 is coupled to the third set of gears 135, and extends to a fourth set of sprockets or gears 141 coaxially supported with the wheel 110. The second chain transfers power from the thirds set of gears 135 to the fourth set of gears 141. In one embodiment, the fourth set of gears 141 comprises a freewheel, which provides rotational power to the wheel in one direction, yet allows free rotation of the wheel without itself having to rotate.

A derailleur 145 is coupled to the frame, and operates to move the second chain between sprockets of the fourth set of gears 141. In one embodiment, a standard derailleur may be used, providing spring tension for the second chain. The derailleur 145 may be controlled via cables and a shift lever or other type of device allowing a rider to change gears of the system 100.

In a further embodiment, a second derailleur 150 is provided to allow the rider to shift gears between the third set of sprockets 135. This provides an increase in the range of gear ratios provided to the rider.

In one embodiment, only the second shaft has multiple sets of sprockets, and the fourth gears 141 comprises a single sprocket that is directly coupled to rotate the wheel 110 in both directions. In this embodiment, only a single wheel is used, and the frame supports a seat for a rider, thus forming a unicycle.

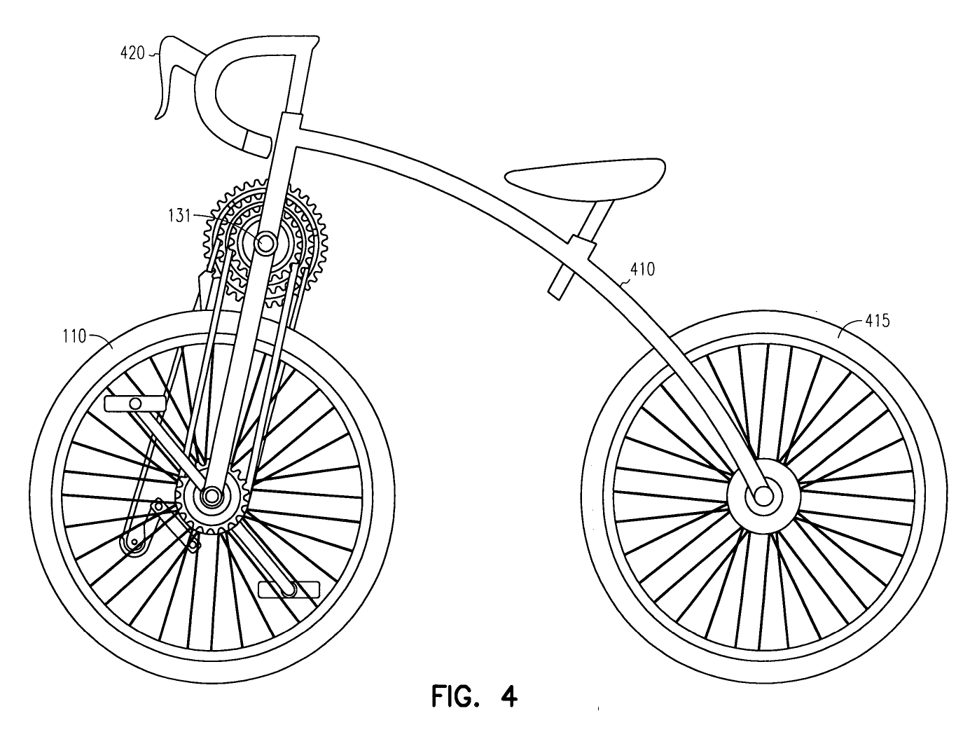

As shown in FIG. 4, a frame 410 may also support a seat 415 for the rider, a second wheel 415, such as a rear wheel, brakes 420, shift cables, and other parts that are common on bicycles. In a further embodiment, the frame supports an additional wheel or wheels, and may take the form of a normal road bicycle, a recumbent bicycle, a Penny Farthing, a three wheeled bicycle or any other desired shape. Wheel 110 comprises a front wheel of such embodiments, or may also comprise a back or middle wheel. The bicycle of FIG. 4 may have further members of the frame to increase support for the various structures coupled to the frame.

In one embodiment, the front wheel is coaxial with the crankshaft and sets of gears. A fork is coupled to the axis of the wheel and extends up to handlebars for steering the bicycle. The second shaft 131 are corresponding gears are coupled to the fork between the handlebars and the axis of the wheel. This provides a multi-speed front wheel drive bicycle. The seat may also be positioned closer to the crankshaft as desired for the convenience of the rider. Many different structures of bicycles, tricycles and motorized bikes may utilize the system 100.

In further embodiments, the sets of sprockets may be located on the same side of the wheel, and/or frame if desired. In one embodiment, only the wheel has a set of multiple sprockets and shift mechanism. The second shaft may only have one sprocket for each chain. In an alternative embodiment, the second shaft has multiple sprockets and a shift mechanism for either one of the chains, with the crankshaft only having a single sprocket for each chain. While the gears have been described as sprockets driven by chains, other arrangements, such as pulleys and belts may be used to transfer power from the crankshaft.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A drive mechanism comprising:
a wheel having a hub;
a crankshaft coaxial with the hub and having an attached crankshaft sprocket;
a power transfer shaft supported radially displaced from the hub and having a first power transfer sprocket for receiving power from the crankshaft sprocket, and having a second power transfer sprocket; and
a set of drive sprockets coupled to the wheel for receiving power from the second power transfer sprocket to rotate the wheel.

2. The drive mechanism of claim 1 and further comprising a derailleur supported proximate the set of drive sprockets.

3. The drive mechanism of claim 2 and further comprising:
a first chain coupling the crankshaft sprocket and the first power transfer sprocket; and
a second chain coupling the second power transfer sprocket to the set of drive sprockets.

4. The drive mechanism of claim 1 wherein the set of drive sprockets comprises a freewheel.

5. The drive mechanism of claim 1 and further comprising a set of pedals coupled to the crankshaft.

6. A drive mechanism comprising:
a first hub having a first set of multiple concentric gears, a concentric drive mechanism, a concentric wheel and a least one first drive gear coupled to the concentric drive mechanism;
a first gear shift mechanism operatively coupled to a first chain on the first set of multiple concentric gears;
a frame coupled to the first hub;
a second hub supported by the frame, and spaced apart from the first hub, the second hub having a second set of multiple gears, and at least one second chain coupled to the at least one first drive gear for driving the concentric wheel.

7. The drive mechanism of claim 6 wherein the drive mechanism comprises pedals.

8. The drive mechanism of claim 7 wherein the frame is a bicycle frame, and the concentric wheel is the front wheel of a bicycle.

9. The drive mechanism of claim 8 and further comprising a back wheel coupled to the frame.

10. The drive mechanism of claim 8, wherein the bicycle has two spaced apart back wheels.

11. A bicycle comprising:
a frame;
a first wheel supported by the frame;
the first wheel having a concentric first hub;
a first gear coupled to the first hub;
means for rotating the first gear;
a first freewheel set of gears coupled to the first hub for selectively driving the wheel in a desired direction;
a first shift mechanism supported by the frame for shifting a first chain between the gears of the first freewheel set of gears;
a second hub coupled to the frame and spaced apart from the first hub;
a second gear coupled to the second hub aligned to support a second chain extending between the second gear and the first gear;
a second set of gears coupled to the second hub positioned to support the first chain;
a second shift mechanism supported by the frame for shifting the first chain between the gears of the second set of gears; and
a second wheel coupled to the frame.

12. The bicycle of claim 11 and further comprising a seat supported by the frame.

13. The bicycle of claim 11 wherein the gears are positioned such that the first chain and drive chain are on opposing sides of a portion of the frame extending between the first and second hubs.

14. A drive mechanism comprising:
a first hub having a first set of multiple concentric gears, a concentric drive shaft, a concentric wheel for providing locomotion and a least one first drive gear;
a first gear shift mechanism for shifting a first chain between gears on the first set of multiple concentric gears;
a frame coupled to the first hub;
a second hub supported by the frame, and spaced apart from the first hub, the second hub having a second set of multiple gears, and at least one second drive gear coupled to the at least one first drive gear for driving the concentric wheel; and
a second gear shift mechanism for shifting a chain between gears on the second set of multiple concentric gears.

15. The drive mechanism of claim 14 wherein the first and second sets of gears are aligned to permit the chain to move between the sets of multiple concentric gears.

16. The drive mechanism of claim 14 wherein the first gear shift mechanism comprises a derailleur supported proximate the set of drive sprockets.

17. The drive mechanism of claim 16 wherein first set of multiple concentric gears comprises a freewheel.

18. The drive mechanism of claim 16 and further comprising a set of pedals coupled to the first drive gear.
